(19) United States
(12) Patent Application Publication
(10) Pub. No.: US 2026/0221586 A1
(43) Pub. Date: Jul. 30, 2026

(54) FLUE GAS STRUCTURE

(71) Applicant: TOYOTA JIDOSHA KABUSHIKI KAISHA, Toyota-shi (JP)

(72) Inventor: Fumiaki AIKAWA, Anjo-shi (JP)

(21) Appl. No.: 19/428,359

(22) Filed: Dec. 22, 2025

(30) Foreign Application Priority Data
Jan. 27, 2025 (JP) 2025-011673

(51) Int. Cl. H01M 50/358; B60R 16/033; H01M 10/613; H01M 10/625; H01M 10/656; H01M 50/249

(52) U.S. Cl. CPC H01M 50/358; B60R 16/033; H01M 10/613; H01M 10/625; H01M 10/656; H01M 50/249; H01M 2220/20

(57) ABSTRACT

A flue gas structure includes: a storage battery cell installed in a vehicle; a lower case disposed at a lower face of the storage battery cell and having a flow path part separated from the lower face of the storage battery cell and configuring a flue gas flow path, a contact part provided at both sides, in a vehicle width direction, of the flow path part and disposed further toward a vehicle upper side than the flow path part, and an inclined part coupling together the flow path part and the contact part; and a cooler disposed at a lower face of the contact part and receiving heat from the storage battery cell, in which the inclined part in the lower case forms an angle from 40 degrees to 90 degrees with a lower face of the storage battery cell corresponding to the flue gas flow path.

### CROSS-REFERENCE TO RELATED APPLICATION

This application is based on and claims priority under 35 USC 119 from Japanese Patent Application No. 2025-011673, filed on January 27, 2025, the entire disclosure of which is incorporated by reference herein.

### BACKGROUND

### Technical Field

The present disclosure relates to a flue gas structure.

### Related Art

Japanese Patent Application Laid-open (JP-A) No. 2023-46945 describes a battery pack having a structure in which plural battery modules are housed in a battery pack, and a cooler is attached to the lower surface of each battery module with a lower case interposed therebetween.

In some cases, a storage battery installed in a vehicle is provided with a flue gas flow path for releasing smoke to the outside of the vehicle in the event that smoke is emitted at the time of a collision or the like.

In a configuration in which a heat receiving member such as a cooler is provided at a lower case at the lower surface of a storage battery cell, it is desirable to secure a large flow path cross-sectional area of the flue gas space; that is, of the flue gas flow path.

It is an object of the present disclosure to provide a large flow path cross-sectional area of a flue gas flow path along which smoke generated at a storage battery cell will flow.

### SUMMARY

A flue gas structure according to a first aspect includes: a storage battery cell installed in a vehicle; a lower case disposed at a lower face of the storage battery cell and having a flow path part separated from the lower face of the storage battery cell and configuring a flue gas flow path, a contact part provided at both sides, in a vehicle width direction, of the flow path part and disposed further toward a vehicle upper side than the flow path part, and an inclined part coupling together the flow path part and the contact part; and a cooler disposed at a lower face of the contact part and receiving heat from the storage battery cell, in which the inclined part in the lower case forms an angle from 40 degrees to 90 degrees with a lower face of the storage battery cell corresponding to the flue gas flow path.

In the flue gas structure of the first aspect, smoke generated at the storage battery cell flows along a flue gas flow path configured between the lower case and the lower face of the storage battery cell. Further, a cooler is arranged at the lower face of the contact part of the lower case, and heat from the storage battery cell can be received by the cooler.

In the lower case, the inclined part coupling together the flow path part and the contact part forms an angle of from 40 degrees to 90 degrees with the lower face of the storage battery cell corresponding to the flue gas flow path. Therefore, compared to a configuration in which the inclined part does not form an angle of from 40 degrees to 90 degrees with the lower face of the storage battery cell, a large flow path cross-sectional area of the flue gas flow path gas can be secured.

A flue gas structure of a second aspect is the flue gas structure of the first aspect, in which: plural of the storage battery cells are aligned in a vehicle front-rear direction, the flue gas flow path extends in common to the plural storage battery cells, and the cooler extends in common to the plural storage battery cells.

In the flue gas structure of the second aspect, the flue gas flow path and the cooler can be provided in common to the plural storage battery cells and the structure can be simplified.

A third aspect is the flue gas structure of the second aspect, in which, in a cross section orthogonal to an extension direction of the flue gas flow path, the flue gas flow path is wider than the contact part.

In the flue gas structure of the third aspect, since the width of the flue gas flow path is large, a large cross-sectional area of the flow path can be secured.

According to the present disclosure, it is possible to secure a large flow path cross-sectional area of a flue gas flow path along which smoke generated at a storage battery cell will flow.

### BRIEF DESCRIPTION OF THE DRAWINGS

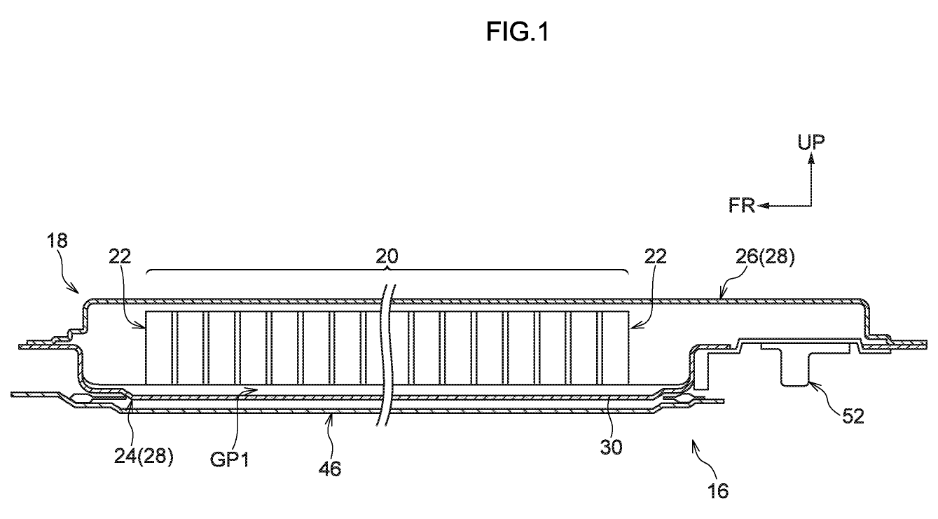

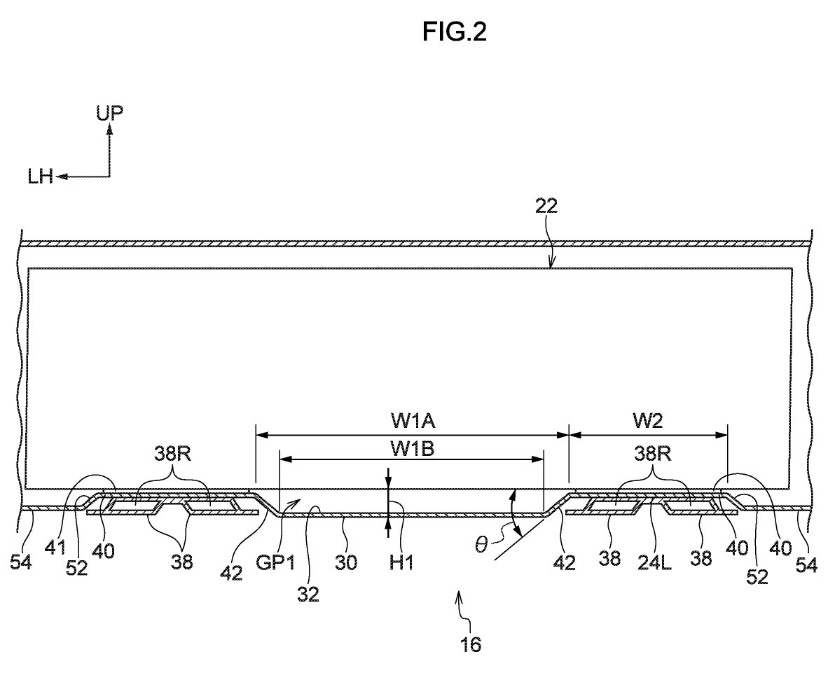

An exemplary embodiment of the present disclosure will be described in detail based on the following figures, wherein:

[FIG. 1]FIG.1 is a longitudinal cross-sectional view showing a flue gas structure of a first embodiment; and

[FIG. 2] FIG. 2 is a lateral cross-sectional view showing a flue gas structure of the first embodiment.

### DETAILED DESCRIPTION

Hereinafter, a flue gas structure of a first embodiment of the present disclosure will be described with reference to the drawings. Note that, in the following, the scope necessary for explaining the technology of the present disclosure is mainly described, and portions regarding which description is omitted are based on known technology. The same or corresponding members in the drawings are denoted by the same or similar reference numerals, and repeated description is omitted. Furthermore, when plural of the same or corresponding members are included in the drawings, only some of them may be denoted by reference numerals for ease of illustration. Arrows FR, UP, and LH in the drawings indicate the vehicle front direction, the vehicle upper direction, and the vehicle left direction in the vehicle, respectively. In the following description, when the front-rear, up-down, and left-right directions are used without special mention, front and rear in the vehicle front-rear direction, up and down in the vehicle up-down direction, and left and right in the vehicle width direction (left-right direction) are respectively indicated.

FIG. 1 is a schematic cross-sectional view showing a vehicle equipped with a flue gas structure 16 of the first embodiment in a cross-section along the vehicle front-rear direction. FIG. 2 is a schematic cross-sectional view showing a vehicle equipped with the flue gas structure 16 in a cross-section along the vehicle width direction.

As shown in FIG. 1, a storage battery pack 18 is installed in a vehicle. The storage battery pack 18 has plural (in the present embodiment, four) storage battery modules 20. The plural storage battery modules 20 are disposed in a row in the vehicle width direction.

Each of the storage battery modules 20 has plural storage battery cells 22. The plural storage battery cells 22 are arranged in a row in the vehicle front-rear direction in the storage battery module 20. In other words, the storage battery pack 18 has a configuration in which plural storage battery modules 20, each having plural storage battery cells 22 arranged in a row in the vehicle front-rear direction, are arranged in a row in the vehicle width direction.

The storage battery pack 18 has a lower case 24 and an upper cover 26. The lower case 24 is a box-shaped member capable of housing the storage battery module 20. The upper cover 26 is a lid-shaped member which closes the upper surface of the lower case 24. The periphery of the lower case 24 and the periphery of the upper cover 26 are connected, and the lower case 24 and the upper cover 26 configure a storage battery case 28. In the space inside the storage battery case 28, plural storage battery modules 20 configured by plural storage battery cells 22 are housed in a row in the vehicle width direction.

A shear panel 46 is arranged below the storage battery pack 18. In the present embodiment, the shear panel 46 covers the lower surface of the storage battery pack 18 and protects the storage battery module 20 from foreign matter on the road surface and the like.

As shown in FIG. 2, a lower plate 24L of the lower case 24 has a contact part 40, a flow path part 30, an inclined part 42, an end inclined part 52, and an end flat part 54. The contact part 40 is a part which contacts the storage battery cell 22 on both sides in the vehicle width direction, being formed at the lower surface of the storage battery cell 22 in a pair that are separated from each other in the vehicle width direction. At the contact part 40, the lower case 24 is adhered to the lower surface of the storage battery cell 22 by, for example, an adhesive 41. In addition, the contact part 40, the flow path part 30, the inclined part 42, the end inclined part 52, and the end flat part 54 are formed at each storage battery module 20, and are common to the plural storage battery cells 22 configuring each storage battery module 20.

The flow path part 30 is formed at the center of the storage battery cell 22 in the vehicle-width-direction so as to be spaced apart from the lower surface of the storage battery cell 22. A gap GP1, extending between and communicating a front end and a rear end of the storage battery module 20, is configured between the lower surface of the storage battery cell 22 and the flow path part 30. The gap GP1 configures a part of the flue gas flow path 32. In the storage battery cell 22, when a gas containing smoke (hereinafter, this gas is simply referred to as “smoke”) is generated for some reason, the smoke is discharged from a center position, in the vehicle width direction, at the lower surface of the storage battery cell 22. Therefore, smoke occurring at the storage battery cell 22 flows into the gap GP1. The flue gas flow path 32 is connected to a flue gas valve 52 that is communicated with the outside. The flue gas valve 52 is provided further toward the vehicle rear side of the storage battery case than a rear end of the storage battery module 20. The configuration is such that smoke flowing along the flue gas flow path 32 is discharged to the outside from the flue gas valve 52 shown in FIG. 1.

In the lower case 24, the contact part 40 is a different part from the flow path part 30, and is provided at both sides of the flow path part 30 in the vehicle width direction. The contact part 40 is disposed at a position closer to the storage battery cell 22 than—that is, at a vehicle upper side relative to—the flow path part 30. The contact part 40 and the flow path part 30 are connected by the inclined part 42. The end inclined part 52 is formed at the opposite side of the contact part 40 from the inclined part 42. A flat end part 54 is formed at the opposite side of the inclined end part 52 from the contact part 40. The end inclined part 52 is inclined in the opposite direction to the inclined part 42. The flat end part 54 is disposed in parallel with the flow path part 30. The inclined part 42, the contact part 40, and the end inclined part 52 are integrally formed continuously and have a convex shape toward the storage battery cell 22 (toward the upper side of the vehicle). The flow path part 30 is formed at each storage battery module 20 so as to extend in the vehicle front-rear direction; that is, in the direction in which the storage battery cells 22 are aligned. The length of the flow path part 30 in the vehicle front-rear direction is approximately the same as the length of the storage battery module 20 in the vehicle front-rear direction, extending continuously in the vehicle front-rear direction across the range in which the storage battery module 20 is aligned.

Below the storage battery module 20, the flue gas flow path 32 is configured, with a part partitioned, by the flow path part 30, the inclined part 42, and the lower surface of the storage battery cell 22. The flue gas flow path 32 has a trapezoidal shape when viewed as a cross section in a lateral direction (vehicle width direction) orthogonal to its extension direction (vehicle front-rear direction). The lower base defined by this trapezoidal flow path part 30 is parallel with the lower surface of the storage battery cell 22. The height H1 of the trapezoidal shape (the distance between the lower surface of the storage battery cell 22 and the flow path part 30) is shorter than the width W1A of the upper base and the width W1B of the lower base of the flue gas flow path 32. The flue gas flow path 32 has a flat trapezoidal shape with a lower base shorter than an upper base and a small height difference. That is, the flue gas flow path 32 has a shape in which the height H1 is shorter than the widths W1A and W1B; in other words, a trapezoidal shape that is long in the vehicle width direction. The widths W1A and W1B of the flue gas flow path 32 are greater than the width W2 of each of the contact parts 40.

The flow path part 30 and the contact part 40 are connected by the inclined part 42 that extends obliquely upward toward the outer side in the vehicle width direction. Further, the inclined part 42 may be perpendicular to the lower surface of the storage battery cell 22. The inclined part 42 refers to a configuration in which, when viewed as a cross section in the vehicle width direction, the angle θ formed between the inclined part 42 and the underside of the storage battery cell 22 that defines the flue gas flow path 32 is from 40 degrees to 90 degrees, and is preferably from 60 degrees to 90 degrees.

A cooler 38 is provided at each of the contact parts 40 of the lower case 24. The cooler 38 is disposed at a height position on the outer side of the flow path part 30 in the vehicle width direction, at the contact part 40 of the lower case 24. In the example shown in FIG. 2, the cooler 38 is disposed inside the convex shape formed by the inclined part 42, the contact part 40, and the end inclined part 52. The coolers 38 are arranged with two on one side of the flue gas flow path 32 in the vehicle width direction, and two on the other side.

The coolers 38 configure refrigerant flow paths 38R extending in the front-rear direction of the vehicle. The storage battery cells 22 can be cooled by refrigerant flowing along the refrigerant flow paths 38R of the coolers 38.

Next, the mechanism of the present embodiment is explained.

In the storage battery cell 22, smoke is not generated under normal conditions; however, if smoke is generated for some reason, the smoke is discharged from the lower surface of the storage battery cell 22 at a central position in the vehicle width direction. This smoke then flows out into the flue gas flow path 32 formed by the gap GP1 between the flow path part 30 of the lower case 24 and the underside of the storage battery cell 22. Furthermore, when the pressure inside the smoke exhaust passage 32 becomes higher than the pressure outside, the smoke is exhausted through the flue gas valve 52.

When viewed as a cross section in the vehicle width direction, the angle θ formed between the inclined part 42 and the lower surface of the storage battery cell 22 that defines the flue gas flow path 32 is from 40 degrees to 90 degrees. Therefore, compared to a configuration in which the inclination angle θ of the inclined part 42 of the lower case 24 is less than 40 degrees, a wider flow path cross-sectional area of the flue gas flow path 32 can be ensured. As a result, a structure can be realized in which smoke flows easily along the flue gas flow path 32.

In this way, from the viewpoint of ensuring a wide flow passage cross-sectional area of the flue gas flow path 32, it is preferable that the inclined part 42 of the lower case 24 be from 60 degrees to 90 degrees. If the inclination angle θ exceeds 90 degrees, the lower base of the trapezoidal shape of the flow path part 30 will be wider than the upper base, making it difficult to form the lower case 24; however, if it is 90 degrees or less, the lower base of the flue gas flow path 32 is the same width as the upper base or narrower, making it easy to mold the lower case 24.

Further, in the present embodiment, the widths W1A and W1B of the flue gas flow path 32 are wider than the width W2 of the contact part 40. In this way, the width of the flue gas flow path 32 is wide, thereby realizing a structure in which the cross-sectional area of the flue gas flow path 32 is ensured to be wide.

Further, in the present embodiment, plural storage battery cells 22 are arranged in a row, and the flue gas flow path 32 extends in common to the plural storage battery cells 22. Further, the coolers 38 also extend in common to the plural storage battery cells 22. As a result, the structure can be simplified compared to a configuration in which the flue gas flow path 32 and the coolers 38 are individually arranged for each of the plural storage battery cells 22.

What is claimed is:

1. A flue gas structure, comprising:
a storage battery cell installed in a vehicle;
a lower case disposed at a lower face of the storage battery cell and having a flow path part separated from the lower face of the storage battery cell and configuring a flue gas flow path, a contact part provided at both sides, in a vehicle width direction, of the flow path part and disposed further toward a vehicle upper side than the flow path part, and an inclined part coupling together the flow path part and the contact part; and
a cooler disposed at a lower face of the contact part and receiving heat from the storage battery cell,
wherein the inclined part in the lower case forms an angle from 40 degrees to 90 degrees with a lower face of the storage battery cell corresponding to the flue gas flow path.

2. The flue gas structure of claim 1, wherein:
a plurality of the storage battery cells are aligned in a vehicle front-rear direction,
the flue gas flow path extends in common to the plurality of storage battery cells, and
the cooler extends in common to the plurality of storage battery cells.

3. The flue gas structure of claim 2, wherein, in a cross section orthogonal to an extension direction of the flue gas flow path, the flue gas flow path is wider than the contact part.
